(19) United States
(12) Patent Application Publication
(10) Pub. No.: US 2010/0314186 A1
(43) Pub. Date: Dec. 16, 2010

(54) AIR HYBRID VEHICLE

(76) Inventor: Thomas Tsoi-Hei MA, Chelmsford Essex (GB)

Correspondence Address: SALTAMAR INNOVATIONS, 1 Mathewson Road, Barrington, RI, 02806, US

(21) Appl. No.: 12/812,983

(22) PCT Filed: Jan. 12, 2009
(86) PCT No.: PCT/GB2009/050020

§ 371 Date: Jul. 15, 2010

(30) Foreign Application Priority Data
Jan. 16, 2008 (GB) 0800720.5
Jun. 16, 2008 (GB) 0810959.7
Jun. 16, 2008 (GB) 0810960.5
Jun. 16, 2008 (GB) 0810967.0
Jun. 18, 2008 (GB) 0811119.7
Jun. 18, 2008 (GB) 0811120.5
Jun. 30, 2008 (GB) 0811872.1
Jul. 7, 2008 (GB) 0812348.1

(51) Int. Cl. B60K 6/12; B60W 20/00

(52) U.S. Cl. 180/165

(57) ABSTRACT

An air hybrid vehicle is described powered by an internal combustion engine (16) which may or may not be equipped with a supercharger or turbocharger (10) for boosting the engine (16). In the invention, power is taken from the vehicle to drive the engine (16) during deceleration or coasting of the vehicle. The engine (16) absorbs kinetic energy from the vehicle and uses that energy to produce boost air which is transferred and stored in a boost air storage tank (34) on board the vehicle at a storage pressure not exceeding 3 bar absolute pressure. The vehicle achieves fuel saving and high performance by boost substitution when this boost air is used to supply the engine (16) for short periods during acceleration or cruising of the vehicle without relying on any air charger, temporarily fulfilling the role of an air charger without actually driving an air charger by substituting the boost normally supplied by an air charger with an equivalent boost produced and stored during regenerative braking. To accommodate a large boost air storage tank (34), the body of the vehicle is adapted with air-tight volumes linked together to form one large storage volume.

### FIELD OF THE INVENTION

The present invention relates to a hybrid vehicle in which energy that would otherwise be wasted during braking is stored for subsequent re-use in the form of pressurised air. The concept of re-using energy recovered while braking a vehicle is often referred to as regenerative braking.

### BACKGROUND OF THE INVENTION

It is known that a regenerative hybrid vehicle can achieve significant reduction in fuel consumption and CO₂ emissions by recovering some of the kinetic energy of the vehicle during deceleration or braking of the vehicle and transforming it into another form of energy which can be stored and later re-used.

One example is the electric hybrid vehicle in which the braking energy is transformed into electric energy and stored in an electric battery for future use. Another example is the inertia hybrid vehicle in which the braking energy is transformed into inertial energy and stored in a spinning flywheel for future use. A further example is the pneumatic hybrid vehicle in which the braking energy is transformed into pneumatic energy and stored in a compressed air tank for future use.

It is also known that engine downsizing significantly reduces the fuel consumption of a motor vehicle by providing a small capacity engine operating near its maximum efficiency under naturally aspirated conditions just big enough to meet the most frequently used low and medium load demands of the vehicle, and then catering for the occasional high load demands by boosting the engine with pressurised air supplied from a turbocharger or supercharger. Such a downsized engine will be lighter and produces the same or even higher maximum torque and power than a bigger and heavier naturally aspirated engine, and a vehicle equipped with this engine will have good performance, fun-to-drive as well as good fuel economy.

### OBJECT OF THE INVENTION

The present invention aims to achieve a high efficiency and low cost air hybrid vehicle.

### SUMMARY OF THE INVENTION

According to the present invention, there is provided an air hybrid vehicle powered by an internal combustion engine, wherein a boost air storage tank is provided on board the vehicle for storing boost air produced using energy derived from braking of the vehicle, and a system of valves for controlling the air flow to the boost air storage tank at times when the engine is driven by the vehicle during deceleration or coasting of the vehicle and from the tank to the engine for combustion in the engine at times when the engine is driving the vehicle during acceleration or cruising of the vehicle, characterised in that the storage pressure in the boost air storage tank does not exceed 3 bar absolute pressure and the boost air from the boost air storage tank is supplied to the engine to boost the engine when the power output of the engine, if operated in a naturally aspirated mode, is insufficient to meet the power demand of the vehicle.

The vehicle of the invention achieves fuel saving and high performance by boost substitution. By this it is meant that the engine is boosted with boost air which has been produced and stored using energy that would otherwise have been wasted during vehicle braking, instead of with boost air produced by an engine driven supercharger or an exhaust driven turbocharger both of which would have required fuel to be burnt in the engine in order to generate the boost air at the equivalent pressure. Thus by boost substitution, this fuel is saved by not loading the engine with any supercharger or turbocharger when the required boost air is supplied to the engine from the boost air storage tank.

Preferred embodiments of the invention propose a variety of ways for producing the boost air using energy derived from braking of the vehicle and storing the boost air in a pressure range of 1 to 3 bar absolute pressure which can be safely used for boosting an engine. For example, when the vehicle is driving the engine during deceleration or coasting of the vehicle, an air blower may be motored by the engine to produce the boost air. Alternatively the engine itself may be motored by the vehicle to produce the boost air. After the deceleration when the engine is driving the vehicle, the air supply to the engine is controlled whereby the stored boost air is used by boost substitution for boosting the engine thus saving fuel during acceleration or cruising of the vehicle.

The term “boost air” is used herein to refer to air that has been pressurised above the ambient pressure by up to 2 bar, this being the boost pressure typically produced by a rotary air charger such as a supercharger or a turbocharger. It is to be distinguished from “pneumatic air” which is air compressed to a much higher pressure but cannot be used safely for boosting the engine unless it is re-expanded down to the boost air pressure. Compared with boost air, using pneumatic air for boosting the engine is the root cause of many inefficiencies: first the compression losses incurred when producing and storing the compressed air at the higher pressure and temperature, then the expansion losses incurred when releasing the high pressure air back to boost air pressure, both of which losses are totally unnecessary and wasteful when only boost air is required.

The present invention is predicated upon the realisation, overlooked in the prior art, that there are important distinctions between producing and storing boost air as opposed to producing and storing pneumatic air which affect the regenerative efficiency very significantly. If boost substitution is the preferred method in the present invention for regenerative energy recovery, then the pneumatic-air hybrid is an inferior approach because it falls into the trap of over-compressing the air. In the pneumatic-air hybrid, whilst the traditional aim intuitively is to increase the energy and power densities in the vehicle using compressed air for mechanical work, the reality is that over-compressing the air has led to the many inefficiencies described earlier which are unnecessary when only the boost air is required. The present invention is aimed at the efficient low pressure production, storage and direct use of the boost air in a new type air hybrid vehicle in contrast to the inefficient high pressure production, storage and mechanical use of pneumatic air in the old type air hybrid vehicle. The boost-air hybrid vehicle of the present invention will have low energy density and low cost whereas the pneumatic-air hybrid vehicle will have higher energy density and require more complicated and higher cost equipment such as compressor, expander and high pressure air accumulator, and yet it is much less efficient when only the boost air is required making it uncompetitive compared with the boost-air hybrid vehicle.

Preferably, the above engine is equipped with a rotary air charger such as a supercharger or a turbocharger connected to the intake system of the engine for boosting the engine while having selectable means for loading and unloading the air charger, that is to say for selectively rendering the air charger operative and inoperative. In this case, after deceleration of the vehicle, at times when the engine is driving the vehicle during acceleration or cruising of the vehicle the rotary air charger is controlled while air is supplied to the engine for combustion in the engine according to one of at least three selectable routes or modes including route a) naturally aspirated when boost is not required and the rotary air charger is unloaded, route b) boost air is delivered from the boost air storage tank to the engine when boost is required and the rotary air charger is unloaded, and route c) boost air is delivered from the rotary air charger to the engine when boost is required and the rotary air charger is loaded. The vehicle achieves fuel saving and high performance by boost substitution in not driving the air charger when the engine is supplied with boost air according to route b) which temporarily fulfils the role of the air charger without actually driving the air charger by substituting the boost normally supplied by the air charger with an equivalent boost produced and stored earlier during braking.

The rotary air charger is herein defined as an air blower in which a rotor is used to push a high flow of boost air at a relatively low elevated air pressure to the engine for supporting combustion in the engine during high load operation and in a sustainable manner such that the air flow delivered by the air blower is sufficient to match or exceed the air demand from the engine continuously when required. The rotary air charger typically operates at a pressure ratio of less than 3:1 which is the ideal device for producing boost air for safely boosting the engine.

The rotary air charger is to be distinguished from a reciprocating air compressor which is not suitable for producing boost air and for maintaining the boost to the engine in a sustainable manner on account of the fact that it is not practical to install a reciprocating air compressor which has sufficient flow capacity at boost air pressure that could match or exceed the air demand from the engine continuously when required. Such a compressor would be very bulky, very heavy and have too high parasitic losses to be viable for boosting the engine directly. On the other hand, the reciprocating air compressor is more suitable for producing pneumatic air at a high energy density operating at a pressure ratio in the region of 10:1 to 20:1, but using it as a boosting device in an engine is very inefficient because of the over-compression of the air to a high pressure and high temperature with significant heat loss and the cooling and expansion of the air back to the boost air pressure without recovering any expansion work when boost is required, as explained earlier.

The rotary air charger may be a supercharger or a turbocharger, or it may be a combined supercharger and turbocharger connected in series supplying the engine. The terms “loading” and “unloading” the air charger are used herein to refer to the control actions of selectively rendering the air charger operative and inoperative. In the case the air charger is a supercharger, the supercharger is loaded by mechanically coupling the supercharger to the engine to be driven by the engine or by coupling the supercharger to an electric motor to be driven by the electric motor while supplying boost air to the engine, and is unloaded by decoupling the supercharger or by relaxing the delivery pressure of the supercharger via an air bypass system with or without the supercharger being driven by the engine or by the electric motor. In the case the air charger is a turbocharger, the turbocharger is loaded by directing the exhaust gases from the engine to drive the turbine of the turbocharger, and is unloaded by diverting a large proportion of the exhaust gases to bypass the turbine of the turbocharger. The latter may be achieved by providing and opening a large waste-gate in the turbocharger. The turbocharger may additionally be unloaded by relaxing the air delivery pressure via an air bypass system across the turbo-blower of the turbocharger. Thus in the above cases, when the air charger is loaded, energy is consumed by the air charger for producing the boost air. When the air charger is unloaded, little or no energy is consumed as the air charger will be idling or disengaged.

The present invention recognises the fact that the energy required for producing the boost air for boosting the engine could be derived at least in part from the regenerative braking energy of the air hybrid vehicle. The more aggressively the engine is downsized, the more frequently the boosting is called upon to meet the dynamic driving demand of the vehicle, and the greater the fuel saving by using the boost air produced from regenerative braking instead of using the boost air that would have to be produced by a supercharger or turbocharger for boosting the engine, i.e. temporarily fulfilling the role of an air charger without actually driving an air charger by substituting the boost normally supplied by an air charger with an equivalent boost produced and stored during regenerative braking. So preferably and advantageously the engine in the present invention is an aggressively downsized internal combustion engine. With the introduction of advanced synthetic and bio fuels, engine downsizing could progress significantly in the future making the present invention more and more effective in the future.

In order to increase the frequency and the level of boost used during normal driving, it is essential to choose a small engine package in relation to the inertia mass of the vehicle. Further increase in the boost utilisation is possible by operating the engine at high dilution (i.e. lean burn and/or high EGR) in what is commonly called lean-boost and high-EGR-boost engines. In the case the engine is a multi-cylinder variable displacement engine having selectable means for activating and de-activating one or more cylinders of the engine, the engine could be set at a reduced displacement so that it operates effectively as a downsized engine thereby improving the boost utilisation.

As mentioned earlier, the boost air may be produced in a variety of ways using energy derived from braking of the vehicle. In one example described in GB0810960.5, at times when the engine is driven by the vehicle during deceleration or coasting of the vehicle, boost air is produced by loading a supercharger absorbing the braking energy and this boost air from the supercharger is diverted from the engine to a boost air storage tank on board the vehicle and stored at the engine boost pressure in the boost air storage tank.

In another example described in GB0810967.0, at times when the engine is driven by the vehicle during deceleration or coasting of the vehicle, boost air is produced whereby the intake air flow to the engine is unrestricted with fuel cut-off and the engine back pressure is maintained at a predetermined equilibrium value by simultaneously applying a flow restriction in the engine exhaust system and controlling the filling rate of pressurised air diverted from the back pressure region of the engine exhaust system into a boost air storage tank on board the vehicle with the result that the braking torque generated within the engine is increased derived from the increased back pressure and the pressurised air is transferred to the boost air storage tank and stored at the engine boost pressure in the boost air storage tank. Thus the engine operates as a four stroke air charger producing and storing the boost air at low energy density when it is motored by the vehicle.

The above examples may be used in parallel, producing separate streams of boost air from the supercharger and from the engine air charger for storage in the boost air storage tank while absorbing the braking energy via both the supercharger and the engine air charger.

In the first example, in the case the vehicle is also a hybrid electric vehicle equipped with electric regenerative braking, the supercharger may be driven by an electric motor using the electrical output of a generator driven by braking energy, thus absorbing the braking energy and producing the boost air.

The above vehicle may be extended to operate as a plug-in air hybrid vehicle equipped with a supercharger. The vehicle has a lead for connection to an electricity mains supply and the supercharger is driven by an electric motor connected to a battery which is rechargeable from the electricity mains supply. The vehicle achieves on-board fuel saving by energy displacement using indirectly mains electricity instead of on-board fuel for driving the supercharger.

The boost-air hybrid vehicle of the present invention differs from the conventional hybrid vehicle in a fundamental way in that it diverts power from the vehicle during deceleration of the vehicle and uses that power to produce and store the boost air at an earlier time which otherwise will have to be produced later during acceleration of the vehicle by taking power from the engine to drive an online air charger. This is a direct trade of energy taken at different times either from the vehicle or from the engine for producing the same boost air, and this boost substitution involves no additional energy transformation step so that in the energy balance the regenerative efficiency is simply the ratio of the efficiencies of producing the boost air using braking energy at an earlier time and using fuel energy in real time respectively. In the case where the two efficiencies are the same, the regenerative efficiency will be 100% for the boost-air hybrid vehicle of the present invention.

In contrast, in the conventional hybrid vehicle, the energy recovery process involves many energy transformation steps. In an example of an electric hybrid vehicle, the braking energy is first transformed from mechanical energy to electric energy and finally to chemical energy stored in the battery. When the energy is taken out for producing work, it is transformed back from chemical energy to electric energy and finally to mechanical energy. Each energy transformation step incurs an efficiency penalty. Assuming 90% efficiency for each step, the regenerative efficiency after four steps will be 66% for the electric hybrid vehicle.

In another example of a pneumatic-air hybrid vehicle, the braking energy is transformed into high pressure pneumatic energy by switching the valve timing of the internal combustion engine so that it operates temporarily as an air compressor driven by the vehicle, and the compressed air is stored in a high pressure air accumulator. When the energy is taken out for producing work, it is transformed back from pneumatic energy to mechanical energy by switching the valve timing of the engine so that it operates temporarily as an air expander driving the vehicle. In this case, there are only two energy transformation steps but the efficiency for each step is low. Assuming 60% efficiency for each step, the regenerative efficiency will be 36% for the pneumatic hybrid vehicle. After the expansion process, the expanded air at the engine boost pressure could be used for boosting the engine thereby improving the regenerative efficiency but this is after going through the energy transformation steps and the efficiency losses are already suffered which highlights the disadvantage of using pneumatic air for boosting the engine as discussed earlier. In the case the compressed air is released directly to the engine boost pressure without using an expander to recover some of the stored energy the regenerative efficiency will be even lower.

Thus the boost-air hybrid vehicle of the present invention is significantly more efficient for regenerative braking in using the braking energy for producing and storing only the boost air at low energy density during deceleration or coasting of the vehicle and this boost air is immediately suitable for boosting the engine whenever required during acceleration or cruising of the vehicle without any unnecessary energy transformation and without relying on any air charger while using boost substitution.

The unique feature of the present invention over the other hybrid vehicles is that the energy recovered from regenerative braking is not transformed and re-used after several energy transformation steps, but instead it is used by boost substitution for producing and storing the boost air at an earlier time which later is supplied directly to the combustion cycle of the engine with no energy overhead (i.e. boost for free) creating an energy balance which puts all the output torque from the engine to the vehicle driveline made available from work already done by the earlier braking torque. This is effectively 100% braking energy recovery in which the additional driveline torque gained during acceleration could be exactly the same as the braking torque absorbed during deceleration which is a very efficient way of regenerative braking.

There are many examples of the pneumatic-air hybrid vehicle in the prior art, but none for the boost-air hybrid vehicle. The difference between these two types of hybrid vehicles depends crucially on the choice of the pressure level at which the boost air is produced and stored, and the consequence of this in terms of the resulting regenerative efficiency is in such huge contrast that this choice of the storage pressure is one of the most important features distinguishing the known types of pneumatic-air hybrid vehicles from the boost-air hybrid vehicle of the present invention.

Another important feature not found in the pneumatic-air hybrid vehicles in the prior art is the use of boost substitution during which any installed air charger must be selectively rendered inoperative so that the air charger does not load the engine when the boost air is supplied to the engine from the boost air storage tank resulting in the fuel saving explained earlier which otherwise would be wasted.

GB2166193/U.S. Pat. No. 4,658,781 describes an air hybrid vehicle in which the engine is motored during braking to produce first compressed exhaust gases and later compressed air diverted from the engine exhaust system to a high pressure air accumulator which is a compressed air installation complete with safety valves, and the compressed gases in the accumulator is later admitted into the cylinders of the engine pushing the pistons in such a way that this action is used to start the engine or move the vehicle. The compressed gases may also be used for operating other pneumatic devices in the vehicle and fuel may be injected with the compressed air for combustion in the engine. Whilst the invention describes the general principles of pneumatic regenerative braking using the compressed air in various ways, it has overlooked the advantage of not over-compressing the air when only boost is required while keeping the air pressure in the air accumulator within the range of the engine boost pressure so that the pressurised air is immediately suitable for boosting the engine.

KR960009206 describes a vehicle equipped with a pneumatic brake absorbing power by means of a reciprocating air compressor of the swash-plate type coupled to the axle of the vehicle while producing some compressed air at high pressure in the process of its operation. The compressor can be loaded or unloaded by adjusting the variable stroke of the swash-plate according to when braking is required or not required, and the compressed air is stored in a high pressure air accumulator and later released into the intake system of the engine. This is a pneumatic-air hybrid where the regenerative efficiency is poor because the method involves over-compression and re-expansion before the air could be used for safely boosting the engine. KR960009206 therefore does not anticipate the present invention in not recognising the advantage of producing and storing only the boost air at the engine boost pressure.

U.S. Pat. No. 5,064,423 describes a turbocharged engine driving an auxiliary air compressor producing compressed air for storage in an air accumulator and the stored compressed air is later released into the intake system of the engine to assist acceleration of the engine when there is a lack of sufficient exhaust gas energy for rapidly energising the turbocharger. U.S. Pat. No. 6,138,616 describes another auxiliary air supply system similar to U.S. Pat. No. 5,064,423. Both systems deliver the stored pneumatic air to the engine at the same time the turbocharger is running driven by the engine but there is no fuel saving because the turbocharger is not rendered inoperative when the stored air is supplied to the engine from the air accumulator.

WO2005113947 describes a method of operating an air hybrid vehicle where compressed air is produced and stored during deceleration of the vehicle by temporarily altering the valve timing of the engine and converting it into an air compressor and the compressed air is stored in a high pressure air accumulator and later used for boosting the engine in parallel with a turbocharger in order to reduce turbo-lag. This is again a pneumatic-air hybrid where the air is over-compressed and has to be re-expanded if boost air is required. Also there is no teaching for selectively unloading the turbocharger which is set up in the conventional manner and is always in the loaded state producing a boost pressure which adds unnecessary load to the engine when compressed air is already being supplied from the air accumulator.

U.S. Pat. No. 5,819,538 describes another turbocharged engine in a vehicle in which an air pump is driven by the vehicle during deceleration of the vehicle to produce compressed air which is stored at a maximum safe pressure in a compressed air tank and this compressed air is injected into the engine intake manifold via a pressure regulator dropping down to the engine boost pressure during periods of turbo-lag at the same time the air through the turbocharger is recirculated in order to maintain a high rotating speed for the turbine rotor of the turbocharger. The invention suffers from the unnecessary waste of energy in over-compressing the air and then releasing the air via a pressure regulator without recovering any expansion work contained in the compressed air, but it contains some elements of boost substitution during the short period before the turbocharger reaches its desired operating speed. However the fuel saving in this invention is very small because the quantity of boost air used does not extend beyond the turbo-lag period whereas most of the fuel saving will come by boost substitution by selectively rendering the turbocharger inoperative during the main acceleration period of the vehicle.

WO2007060274 describes another auxiliary air supply system for a turbocharged engine in which an engine driven or separately driven auxiliary rotary air blower is used to supply pressurised air which will be at the engine boost pressure into an air storage tank and the stored air is used to assist the turbocharger of the engine when there is lack of sufficient exhaust gas energy to drive the turbocharger. This is thermodynamically more efficient with no unnecessary energy transformation. However there is no teaching for producing the boost air using energy derived from braking of the vehicle nor supplying the stored air to the engine according the principle of boost substitution with the auxiliary air blower and the turbocharger selectively unloaded and not driven by the engine while boost is supplied to the engine from the boost air storage tank.

The present invention is also to be distinguished from a vehicle powered by a mechanically supercharged engine described in JP61031622 in which the supercharger is loaded for a short prescribed time during deceleration of the vehicle in order to increase the stopping power of the vehicle when braking, and immediately after braking very briefly increase the accelerating power of the engine derived from the pent-up pressure accumulated in the intake pipe of the engine, but there is no separate air storage tank for storing the air at the engine boost pressure. In this case, the supercharger is intentionally run to overload forcing the air into the small space of the intake pipe of the engine which is shut for air flow, with the result that the delivery pressure of the supercharger will overshoot significantly above its rated maximum pressure while the air flow through the supercharger will drop because there is no place for the air to go, and the temperature of the supercharger will rise as most of the energy fed to the supercharger is dissipated irreversibly into heat. Thus JP61031622 suffers seriously from the unnecessary waste of energy in over-compressing the air and there is no fuel saving from boost substitution because the supercharger remains loaded when this air is used to boost the engine.

It is also known in the laboratory in the process of developing an engine that there are situations where for convenience a simulated boost is supplied to the engine using shop air without installing a rotary air charger to the engine. The energy required for producing the boost air is then deducted in the experimental data in order to arrive at the real fuel consumption and power output of the engine when it is equipped with an online air charger. This is akin to the idea of boost substitution but it does not make use of regenerative braking energy from a vehicle to produce the boost air and it does not provide for selectively loading and unloading of any air charger on board the vehicle during air hybrid operation.

In the present invention, the low energy density boost air storage tank will have a very large storage volume for storing and supplying copious quantity of pressurised air at the engine boost pressure thereby producing significant fuel saving during the operation of the boost-air hybrid vehicle. This is in contrast to the much higher energy density and smaller volume air accumulator found in a pneumatic-air hybrid vehicle where the tank volume is typically less than 10 times the volumetric displacement of the engine and the accumulator is constructed as a strong pressure vessel for holding compressed air at a storage pressure many times the engine boost pressure. In the event this air accumulator is discharged almost completely down to the pressure level of the engine boost pressure, there will be very little pressurised air left in the accumulator to supply boost to the engine for no more than 20 engine revolutions or 0.4 second duration at an average engine speed of 3000 rpm which is insignificant for producing any fuel saving by the boost substitution method of the present invention.

As a guide, in the boost-air hybrid vehicle, the volume of the boost air storage tank should be at least 100 times the volumetric displacement of the engine and preferably several 100s times the volumetric displacement for sufficient air to be stored at the engine boost pressure during vehicle deceleration and for this air to be used to boost the engine for a large number of engine revolutions extending over a duration of many seconds during vehicle acceleration so as to produce a significant fuel saving. As explained earlier, unique to the boost-air hybrid vehicle of the present invention having 100% regenerative efficiency, all the braking energy diverted to produce the boost air as much as can be stored in the boost air storage tank at the engine boost pressure will translate directly to fuel saving: the larger the volume of the air storage tank, the bigger the fuel saving.

For example, a 400 litre air storage tank could supply boost air by boost substitution to a 1.5 litre engine for approximately 500 engine revolutions or 10 seconds duration at an average engine speed of 3000 rpm, matching the vehicle demand of a typical decel/accel cycle during urban driving and is immediately available with little time lag.

Since the storage pressure in the boost air storage tank will be similar to the boost pressure used in the engine (i.e. 1 to 3 bar absolute pressure), the tank can be thin-walled, light-weight and can easily be shaped, sub-divided and linked to form one large storage volume integrated into various parts of the body structure of the vehicle. For example, air-tight volumes may be created in the doors, tailgate, wings, pillars, chassis sub-frame, behind the bumpers, under the seats etc and in the luggage compartment of the vehicle. This makes the body of the vehicle an essential component of the boost-air hybrid system which does not add cost or weight if it is designed as part of the body-in-white original equipment. Another air storage tank provided in the vehicle may be arranged in the form of an air bellow preloaded to extend in length when the air pressure within the bellow exceeds a predetermined value above the ambient pressure.

Thus the volume and the construction of the boost air storage tank for storing boost air at the engine boost pressure are further unique features of the boost-air hybrid vehicle of the present invention, distinguishing it from the known types of pneumatic-air hybrid vehicles.

The present invention is applicable to any vehicle powered by a spark ignition or compression ignition engine with or without an air charger. Compared with a non-hybrid vehicle powered by a similar engine, the present invention converts it to a high efficiency boost-air hybrid vehicle with only a few additional components at low technology and low cost and there is no adverse effect on the performance and driveability of the vehicle while the energy balance is shifted substantially towards better fuel economy.

### BRIEF DESCRIPTION OF THE DRAWINGS

The invention will now be described further by way of example with reference to the accompanying drawings in which

FIG. 1a is a schematic drawing of the control means for operating a boost-air hybrid vehicle according to the present invention in which the boost air is produced by a method described in GB0810960.5,

FIG. 1b is a schematic drawing of the control means for operating another boost-air hybrid vehicle in which the boost air is produced by an alternative method described in GB0810967.0,

FIGS. 2a and 2b are diagrammatic illustrations of the boost-air hybrid concept of the present invention in a self-explanatory manner,

FIG. 3 is a schematic drawing of a computer control system for coordinating the boost-air hybrid operation of the vehicle of the present invention.

### DETAILED DESCRIPTION OF THE PREFERRED EMBODIMENT

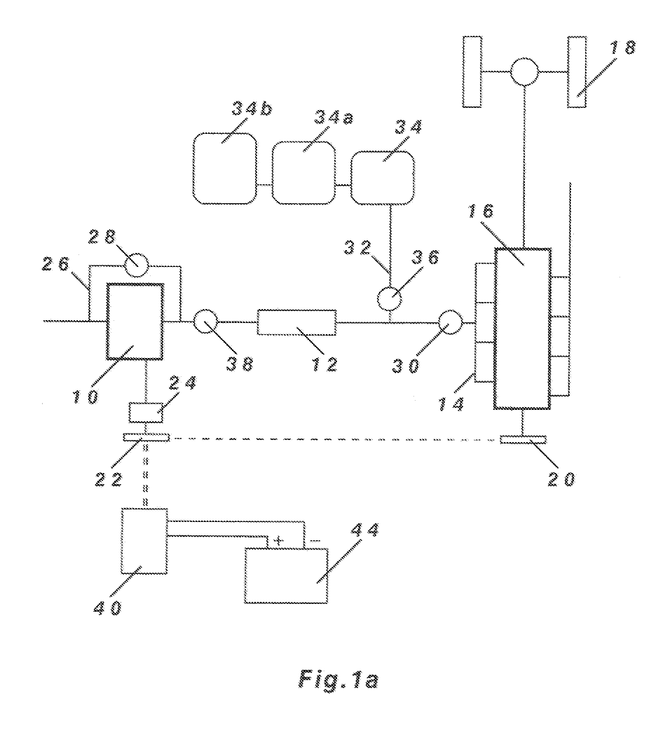

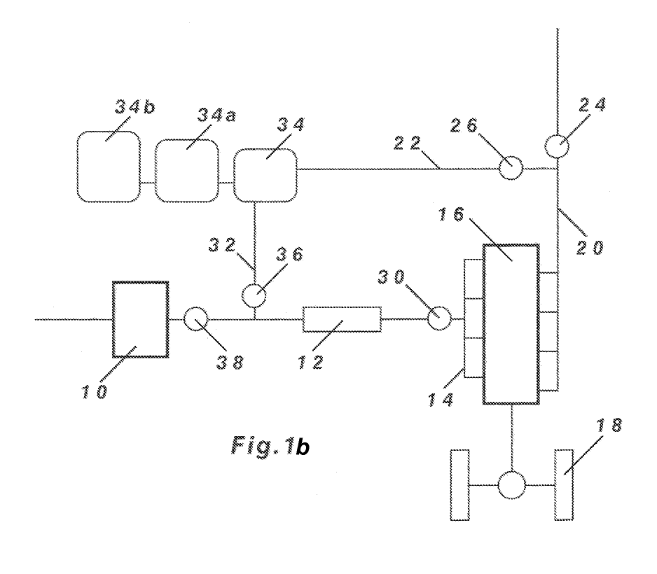

FIG. 1a shows an internal combustion engine 16 driving the wheels 18 of a road vehicle. The engine 16 is equipped with a supercharger 10 supplying boost air to the engine via an intercooler 12 and intake manifold 14. The supercharger 10 may be driven by the engine from a pulley 20 in the engine to a pulley 22 in the supercharger as shown by the single dashed line. The pulley 22 may be a clutch pulley which can be engaged or disengaged at any time on demand. Alternatively, the supercharger 10 may be driven by an electric motor 40 as shown by the double dashed line. A variable speed ratio drive 24 is also shown for driving the supercharger 10 at an optimum speed ratio with the engine.

The supercharger 10 has an air bypass system comprising a bypass connection 26 between the entry and the exit of the supercharger 10 controlled by a bypass valve 28. When boost is required, the bypass valve 28 is closed and the supercharger 10 is driven on load to produce boost air delivered to the engine 16. When boost is not required, the bypass valve 28 is opened, allowing naturally aspirated air to be drawn into the engine 16 while the delivery pressure of the supercharger 10 is relaxed so that the supercharger is unloaded even though it may still be driven by the engine. Ideally the supercharger 10 is also decoupled from the engine 16 by the clutch pulley 22 when boost is not required, or if driven by an electric motor 40, the motor 40 is switched off. In so far described, the setup of the supercharger 10 with selectable means for loading and unloading the supercharger is conventional and suitable for application in a downsized internal combustion engine.

In FIG. 1a, for a road vehicle powered by an internal combustion engine 16 equipped with a supercharger 10 which can be loaded or unloaded at any time on demand, the present invention converts it to an air hybrid vehicle by including a boost air storage tank 34 on board the vehicle and a system of valves for controlling the air flow to the boost air storage tank 34 at times when the engine 16 is driven by the vehicle during deceleration or coasting of the vehicle and from the tank 34 to the engine 16 for combustion in the engine 16 at times when the engine 16 is driving the vehicle during acceleration or cruising of the vehicle comprising:

1) a first throttle valve 30 located downstream of the supercharger 10 for regulating and blocking the air flow from the supercharger 10 to the air intake system 14,
2) an air flow branch 32 connecting from upstream of the first throttle valve 30 to a boost air storage tank 34 on board the vehicle for diverting the supercharger boost air from the engine 16 to the tank 34 when the first throttle valve 30 is closed,
3) a combined air filling and air dispensing valve 36 located in the air flow branch 32 for regulating and sealing the air flow branch 32, and
4) a second throttle valve 38 (or a non-return valve 38) located downstream of the supercharger 10 and upstream of the air flow branch 32 for blocking any back flow of boost air through the bypass system 26, 28 of the supercharger 10 when the boost air in the air storage tank 34 is delivered via the air flow branch 32 to the engine 16 and the supercharger 10 is unloaded.

The second throttle valve 38 or the non-return valve 38 will serve the same function for guarding the air connection to and from the supercharger 10. The non-valve valve has the advantage of being automatic, driven by the pressure difference across the valve so that it will close as soon as there is a back flow into the supercharger 10 in a direction reverse to the normal supply flow of supercharger 10. The air throttle valve, on the other hand, will have to be controlled by an actuator, but it could be opened and closed more fully and more quickly than the non-return valve.

The above system of valves enable the vehicle to be programmed to operate in different air hybrid modes by switching to different operating strategies affecting the use of the supercharger 10 as follow:
At times when the engine 16 is driven by the vehicle during deceleration or coasting of the vehicle boost air is produced by loading the supercharger 10 and the boost air from the supercharger 10 is diverted from the engine 16 to the boost air storage tank 34 so as to boost the air pressure within the tank 34,
At times when the engine 16 is driving the vehicle during acceleration or cruising of the vehicle the supercharger 10 is controlled while air is supplied to the engine 16 for combustion in the engine 16 according to one of at least three selectable routes or modes:
   route a) naturally aspirated when boost is not required and the supercharger 10 is unloaded,
   route b) boost air is delivered from the air storage tank 34 to the engine 16 when boost is required and the supercharger 10 is unloaded,
   route c) boost air is delivered from the supercharger 10 to the engine 16 when boost is required and the supercharger 10 is loaded.

The vehicle achieves fuel saving and high performance by boost substitution in not driving the supercharger 10 when the engine 16 is supplied with boost air according to route b) which temporarily fulfils the role of the supercharger 10 without actually driving the supercharger 10 by substituting the boost normally supplied by the supercharger 10 with an equivalent boost produced and stored during regenerative braking.

Thus in FIG. 1a, at times when the engine 16 is driven by the vehicle during deceleration or coasting of the vehicle the supercharger 10 is loaded at the same time the first throttle valve 30 is closed while the second throttle valve 38 is opened (or the non-return valve 38 automatically opens) and the air filling valve 36 is opened until the air pressure in the air storage tank 34 reaches a desired boost value at which point the air filling valve 36 is closed. In this case, boost air from the supercharger 10 is diverted from the engine 16 to the air storage tank 34 to boost the air pressure in the tank 34.

After the deceleration when the engine 16 is driving the vehicle and the air supply to the engine 16 is selected according to route a), the supercharger 10 is unloaded at the same time the air dispensing valve 36 is closed while the first throttle valve 30 is opened and the second throttle valve 38 is opened (or the non-return valve 38 automatically opens). In this case, naturally aspirated air is delivered to the engine 16 through the supercharger bypass system 26, 28 which is open.

At times when the engine 16 is driving the vehicle during acceleration or cruising of the vehicle and the air supply to the engine is selected according to route b), the supercharger 10 is unloaded at the same time the air dispensing valve 36 and the first throttle valve 30 are opened while the second throttle valve 38 is closed (or the non-return valve 38 automatically closes) until the air pressure in the air storage tank 34 falls below a predetermined value at which point the air dispensing valve 36 is closed and the second throttle valve 38 is opened (or the non-return valve 38 automatically opens). In this case, boost air is connected from the air storage tank 34 to the engine 16 to boost the engine 16 until the air pressure in the tank 34 is depleted. The vehicle achieves fuel saving and high performance by not driving the supercharger 10 when this boost air is used to supply the engine 16.

At times when the engine 16 is driving the vehicle during acceleration or cruising of the vehicle and the air supply to the engine is selected according to route c), the supercharger 10 is loaded at the same time the air dispensing valve 36 is closed while the first throttle valve 30 is opened and the second throttle valve 38 is opened (or the non-return valve 38 automatically opens). In this case, boost air from the supercharger 10 is delivered directly to the engine 16 to boost the engine 16.

In FIG. 1a, in the case the vehicle is also a hybrid electric vehicle equipped with electric regenerative braking, the supercharger 10 may be driven by an electric motor using the electrical output of a generator driven by braking energy, thus absorbing the braking energy and producing the boost air.

The above vehicle in FIG. 1a may be extended to operate as a plug-in air hybrid vehicle. The vehicle has a lead for connection to an electricity mains supply and the supercharger 10 is driven by an electric motor 40 connected to a battery 44 which is rechargeable from the electricity mains supply. The vehicle achieves on-board fuel saving and high performance by energy displacement using indirectly mains electricity instead of on-board fuel for driving the supercharger 10.

FIG. 1b shows another internal combustion engine 16 driving the wheels 18 of a road vehicle. The engine 16 may be naturally aspirated or boosted by a rotary air charger, and the latter option is chosen for illustration in FIG. 1b. In FIG. 1b the engine 16 is equipped with a rotary air charger 10 supplying boost air to the engine 16 via an intercooler 12 and intake manifold 14. Exhaust gases from the engine 16 is discharged via an exhaust manifold and exhaust pipe 20. The rotary air charger 10 may be an engine driven supercharger or exhaust driven turbocharger installed in the conventional manner but this is not shown in FIG. 1b in order to avoid unnecessary complexity in the diagram. The rotary air charger 10 may also be a combined supercharger and turbocharger connected in series supplying the engine 16. The selectable means for loading and unloading the rotary air charger 10 are also not shown in FIG. 1b for the same reason since they are conventional components including clutch, air bypass, waste-gate etc. In so far described, the setup of the air charge system 10, 12, 14 for supplying air to the engine 16 and the exhaust system 20 for discharging gases from the engine 16 is conventional.

In FIG. 1b, the air hybrid vehicle is provided with the following system of air control valves:

1) a back pressure valve 24 for regulating or blocking the exhaust pipe of the engine 16,
2) a first air flow branch 22 connecting from between the engine 16 and the back pressure valve 24 to the boost air storage tank 34 for diverting boost air from the back pressure region 20 of the engine exhaust system into the air storage tank 34 when the back pressure valve 24 is closed,
3) an air filling valve 26 located in the air flow branch 22 for regulating and sealing the air flow branch 22,
4) a second air flow branch 32 connecting from the boost air storage tank 34 to the intake system of the engine 16 between the rotary air charger 10 and the engine 16,
5) an air dispensing valve 36 located in the air flow branch 32 for regulating and sealing the air flow branch 32, and
6) an air throttle valve 38 (or a non-return valve 38) located downstream of the rotary air charger 10 and upstream of the second air flow branch 32 for blocking any back flow of boost air through the rotary air charger 10 when the boost air in the boost air storage tank 34 is delivered via the second air flow branch 32 to the engine 16.

The above system of valves enable the vehicle to be programmed to operate in different air hybrid modes by switching to different operating strategies affecting the use of the rotary air charger 10 in a similar manner to the system illustrated in FIG. 1a.

Thus in FIG. 1b, at times when the engine 16 is driven by the vehicle during deceleration or coasting of the vehicle, boost air is produced whereby the intake air flow to the engine is unrestricted with fuel cut-off at the same time the back pressure valve 24 is closed and the air dispensing valve 36 is also closed while the air filling valve 26 is opened until the air pressure in the boost air storage tank 34 reaches a predetermined value at which point the air filling valve 26 is closed. In this case, the engine 16 operates as a four stroke air charger motored by the vehicle and pressurised air is diverted from the back pressure region 20 of the engine exhaust system to the boost air storage tank 34 to boost the air pressure in the tank 34.

After the deceleration when the engine 16 is driving the vehicle and the air supply to the engine 16 is selected according to route a), the rotary air charger 10 is unloaded at the same time the back pressure valve 24 is opened while the air filling valve 26 and the air dispensing valve 36 are closed and the air throttle valve 38 is opened (or the non-return valve 38 automatically opens). In this case, naturally aspirated air is delivered to the engine 16 through or bypassing the rotary air charger 10.

At times when the engine is driving the vehicle during acceleration or cruising of the vehicle and the air supply to the engine 16 is selected according to route b), the rotary air charger 10 is unloaded at the same time the back pressure valve 24 is opened and the air filling valve 26 is closed while the air dispensing valve 36 is opened and the air throttle valve 38 is closed (or the non-return valve 38 automatically closes) until the air pressure in the boost air storage tank 34 falls below a predetermined value at which point the air dispensing valve 36 is closed and the air throttle valve 38 is opened (or the non-return valve 38 automatically opens). In this case, boost air is connected from the boost air storage tank 34 to the engine 16 to boost the engine 16 until the air pressure in the tank 34 is depleted. The vehicle achieves fuel saving and high performance by not driving the rotary air charger 10 when this boost air is used to supply the engine 16.

At times when the engine is driving the vehicle during acceleration or cruising of the vehicle and the air supply to the engine 16 is selected according to route c), the rotary air charger 10 is loaded at the same time the back pressure valve 24 is opened and the air filling valve 26 and air dispensing valve 36 are closed while the air throttle valve 38 is opened (or the non-return valve 38 automatically opens). In this case, boost air from the rotary air charger 10 is delivered directly to the engine 16 to boost the engine 16.

In the case in FIG. 1b the air hybrid vehicle is powered by a boosted spark ignition engine 16, the main throttle 30 of the engine 16 is an additional valve in the air hybrid system which has to be controlled according to the deceleration or acceleration mode of the vehicle. Thus at times when the engine 16 is driven by the vehicle during deceleration or coasting of the vehicle, the main throttle 30 is opened to allow unrestricted air flow through the engine 16 working as a four stroke air charger for producing the boost air. At times when the engine 16 is driving the vehicle during acceleration or cruising of the vehicle, the main throttle 30 is used to regulate the power output of the engine 16 in the conventional manner.

In the above methods illustrated in FIGS. 1a and 1b for producing and storing the boost air, the air pressure in the boost air storage tank 34 will be similar to the boost pressure used in the engine 16 (i.e. 1 to 3 bar absolute pressure), so the tank 34 can be thin-walled, light-weight and can easily be shaped, sub-divided and linked to form one large storage volume integrated into various parts of the body structure of the vehicle. For example, air-tight volumes may be created in the doors, tailgate, wings, pillars, chassis sub-frame, behind the bumpers, under the seats etc and in the luggage compartment of the vehicle. This makes the body of the vehicle an essential component of the boost-air hybrid system which does not add cost or weight if it is designed as part of the body-in-white original equipment. Another air storage tank provided in the vehicle may be arranged in the form of an air bellow preloaded to extend in length when the air pressure within the bellow exceeds a predetermined value above the ambient pressure. As explained earlier, unique to the boost-air hybrid vehicle of the present invention, all the braking energy diverted to produce the boost air as much as can be stored in the boost air storage tank 34 will translate directly to fuel saving: the larger the volume of the tank 34, the bigger the fuel saving.

For example, a 400 litre air storage tank could supply boost air by boost substitution to a 1.5 litre engine for approximately 500 engine revolutions or 10 seconds duration at an average engine speed of 3000 rpm, matching the vehicle demand of a typical decel/accel cycle during urban driving and is immediately available with little time lag.

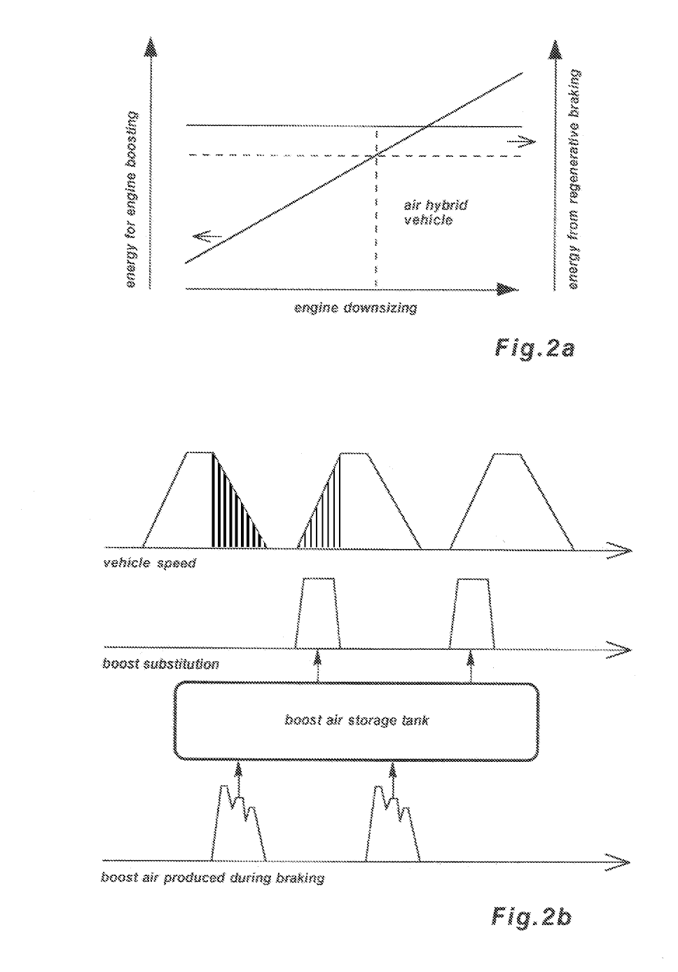

FIGS. 2a and 2b show in a self-explanatory manner the boost-air hybrid concept of the present invention in which power is taken from the vehicle to drive the engine during deceleration or coasting of the vehicle. The engine absorbs kinetic energy from the vehicle and uses that energy to produce boost air which is transferred and stored in a boost air storage tank on board the vehicle at a storage pressure not exceeding 3 bar absolute pressure. The vehicle achieves fuel saving and high performance by boost substitution when this boost air is used to supply the engine for short periods during acceleration or cruising of the vehicle without relying on any air charger, temporarily fulfilling the role of an air charger without actually driving an air charger by substituting the boost normally supplied by an air charger with an equivalent boost produced and stored during regenerative braking.

This illustrates the advantage of the present invention over the other hybrid vehicles in that the energy recovered from regenerative braking is not transformed and re-used after several energy transformation steps, but instead it is used by boost substitution for producing and storing the boost air at an earlier time which later is supplied directly to the combustion cycle of the engine with no energy overhead (i.e. boost for free) creating an energy balance which puts all the output torque from the engine to the vehicle driveline made available from work already done by the earlier braking torque. This is effectively 100% braking energy recovery in which the additional driveline torque gained during acceleration could be exactly the same as the braking torque absorbed during deceleration which is a very efficient way of regenerative braking.

In FIG. 2a, depending on the frequency and the level of boost required for a downsized engine to drive a vehicle in a predetermined average set of journeys comprising an estimated number of accelerations and decelerations, there is an optimum combination of the engine and the vehicle where the energy required for boosting the engine would match the energy recovered from regenerative braking in which case the maximum fuel saving would be achieved by boost substitution. Thus a good guide for selecting a downsized engine to drive the boost-air hybrid vehicle of the present invention in an average journey in urban setting comprising an estimated number of accelerations and decelerations is that the total energy required for boosting the engine should exceed the total energy recovered from regenerative braking, in which case all the available energy recovered from regenerative braking would be fully utilised by boost substitution.

An average journey is herein defined as a journey representative of typical use derived from statistical data taken from a large population of vehicle journeys in a representative set of driving conditions. It is therefore a statistically valid set of driving modes that could be used for optimising the design of the boost-air hybrid vehicle of the present invention.

In order to perform the boost-air hybrid operation according to FIG. 2b and provide smooth and precise control of the vehicle for the driver in all kinds of driving and braking situations, an on-board computer will be required to control the filling and emptying of the boost air storage tank 34. The computer will also control the vehicle brakes on the road wheels in order to share the braking torque absorbed by the supercharger and/or engine air charger and by the vehicle brakes in the most efficient and comfortable manner. Thus the boost-air hybrid vehicle of the present invention will have drive-by-wire and brake-by-wire control systems, taking the driving and braking demand signals from the accelerator and brake pedals of the vehicle and translating the signals into driving and braking response actions according to the state of fill of the boost air storage tank 34. The objective is to achieve good driveability in a manner which is transparent to the driver.

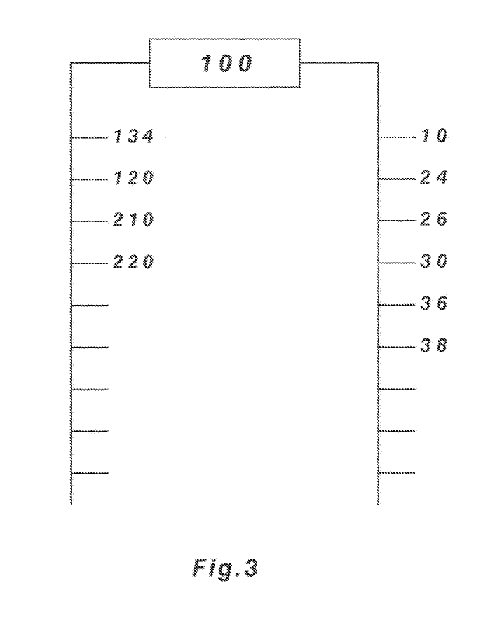

FIG. 3 shows an on-board Electronic Control Unit ECU 100 taking input data from a state-of-fill sensor 134 in the boost air storage tank 34 and a pressure sensor 120 in the back pressure region 20 of the engine exhaust system, and from the accelerator and brake pedals 210, 220 of the vehicle, as well as from a variety of sensors indicating, among others, the state of the transmission and the state of motion of the vehicle. The input data are processed within the ECU 100 which translates them into the appropriate output command signals for operating, among others, the loading and unloading of the rotary air charger 10, and the control valves 24, 26, 30, 36, 38 shown in FIGS. 1a and 1b. The ECU 100 could also provide information to the driver of the vehicle indicating the rate and the level of boost air being stored or consumed in the vehicle. The driver could use the information and adapt his or her driving style and gear shift habit to achieve the maximum regenerative braking and the lowest fuel consumption for the vehicle.

1-10. (canceled)

11. Air hybrid vehicle comprising:
an internal combustion engine having a volumetric displacement, and an air intake system;
a boost storage tank coupled to the vehicle, the boost storage tank having a total storage volume of at least 100 times the volumetric displacement of the engine;
wherein the boost storage tank is configured to store boost air produced using energy derived from braking of the vehicle at a storage pressure not exceeding 3 bar absolute;
the boost storage tank comprising a bellows preloaded to extend in length when the pressure within the bellows exceeds a predetermined value above the ambient pressure; and,
a valve system arrange for controlling air flow to and from the boost tank, such that pressurized air is supplied to the tank for storage during deceleration or coasting of the vehicle and supplied from the tank to the engine for boosting the engine during acceleration or cruising of the vehicle.

12. An air hybrid vehicle as claimed in claim 11, wherein the engine further comprises at least one selectively operable rotary air charger coupled to the intake system for boosting the engine, the air charger being rendered operative during deceleration or coasting of the vehicle to produce the boost air for storage in the boost storage tank and being rendered inoperative during acceleration or cruising of the vehicle when the engine is boosted by means of the boost air supplied from the boost air storage tank.

13. An air hybrid vehicle as claimed in claim 12, wherein the rotary air charger is a supercharger driven by the engine.

14. An air hybrid vehicle as claimed in claim 12, wherein the rotary air charger is driven by an electric motor, the vehicle further comprises:
a generator at least partially driven by braking energy, the generator being coupled to the electric motor driving the rotary air charger.

15. An air hybrid vehicle as claimed in claim 12, wherein the vehicle further comprises a rechargeable battery chargeable by an electricity mains supply, and wherein the supercharger is drivable by an electric motor coupled to the battery.

16. An air hybrid vehicle as claimed in claim 11, wherein when the engine is driven by the vehicle during deceleration or coasting of the vehicle, the engine is being operated with an unrestricted intake system, with fuel cut-off and with a restriction in the exhaust system, for raising the exhaust back pressure sufficiently to divert boost air from the exhaust system to the boost air storage tank.

17. An air hybrid vehicle as claimed claim 11, wherein the boost storage tank comprises a plurality of air-tight volumes integrated into various parts of the body structure of the vehicle and linked together to form one effective storage volume.

18. An air hybrid vehicle as claimed in claim 11, further comprising an electronic control unit for coordinating the boost-air hybrid operation of the vehicle by taking the driving and braking demand signals from the accelerator and brake pedals of the vehicle respectively, and translating the signals into corresponding driving and braking response actions.

19. An air hybrid vehicle as claimed in claim 11, wherein the engine is operated at high air/EGR dilution rates.

20. An air hybrid vehicle as claimed in claim 11, wherein the engine has means for selectively activating and de-activating one or more cylinders of the engine in order to vary the effective displacement of the engine.
